(19) United States
(12) Patent Application Publication
(10) Pub. No.: US 2007/0008817 A1
(43) Pub. Date: Jan. 11, 2007

(54) Clear rigid acrylic sleeve for mounting paint bottle on paint mixer

(76) Inventor: Russell D. Gerner, Henderson, NV (US)

Correspondence Address: Donald W. Meeker;Patent Agent, 924 East Ocean Front #E, Newport Beach, CA, 92661, US

(21) Appl. No.: 11/178,166

(22) Filed: Jul. 8, 2005

(51) Int. Cl. B01F 11/00

(52) U.S. Cl. 366/208

(57) ABSTRACT

A clear rigid sleeve equal in height to a paint bottle height and equal in internal diameter to an external diameter of a paint bottle. The sleeve structured to fit within a paint mixing machine clamp and retain a plastic paint bottle within the sleeve while the paint mixing machine mixes paint in the paint bottle. The transparent surface of the sleeve enables viewing through the sleeve to determine when the paint is fully mixed. Indicia may be imprinted on an exterior surface of the sleeve.

### BACKGROUND OF THE INVENTION

1. Field of the Invention

The present invention relates to paint shakers and particularly to a rigid clear acrylic sleeve used to hold a bottle of paint in a friction-fit arrangement therein, said sleeve is held in place by the clamping device on a paint shaker and allows the paint to be observed through both the bottle and the sleeve during the mixing process.

2. Description of the Prior Art

Normally, repairs performed by automotive body repair and paint shops require the use small amounts of paint to complete a job. However, most paint shakers are usually large, heavy machines adapted for shaking 4 liter or 1 gallon containers. The plastic paint bottles cannot be used directly in standard paint shaking machines because the bottles are not rigid enough to withstand the pressure of the paint can holders in the machines.

Because of the small quantity of paint in the plastic paint containers an comparison with the large quantity of paint in a standard paint can normally shaken in the paint mixing machines, it would be important to be able to detect when the paint in the plastic containers was fully mixed to stop the machine and not run it the normal amount of time required to mix a large can of paint.

U.S. Pat. No. 4,316,672, issued Feb. 23, 1982 to Kerscher, describes a vibration or shaking machine, especially for Indian ink writing devices, said machine having a housing with a guide in which is guided a sliding holder for holding at least one of the objects to be shaken, as well as a driving motor for the holder in the housing.

U.S. Pat. No. 4,173,418, issued Nov. 6, 1979 to Vork, is for an apparatus for mixing liquids such as paints in closed containers. The apparatus includes a motor drive unit coupled to a drive pulley to produce a constant rotational speed. The drive pulley is connected via an eccentric crank to a shaker plate which has mounted therein a container housing, the shaker plate being also supported from at least two other points by similar crank couplings so as to produce a circular oscillating motion when the drive motor is actuated. An alternative construction utilizes a sleeve, which has an inside diameter for snugly fitting around a paint container without permitting relative rotational motion between sleeve and paint container.

U.S. Pat. No. 3,061,280, issued Oct. 30, 1962 to Kraft, provides an apparatus for mixing fluent material which has a tube-shaped resilient cup for holding test tubes or the like.

U.S. Pat. No. 3,159,384, issued Dec. 1, 1964 to Davis, shows an agitator for laboratory tubes and flasks having a sleeve-like, semi-rigid tube holding cup.

U.S. Pat. No. 3,981,487, issued Sep. 21, 1976 to Papoff, claims a device for mixing liquids in kinetic reactions observed by the method known as stopped flow. The device comprises a housing, having an annular chamber, the outer walls whereof are connected with conduits to feed the liquids to be mixed; and the inner walls whereof with radial, conical conduits which are perpendicular to the first mentioned conduits and which lead into a central chamber. Said central chamber communicates by asymmetric conduits with an observation cell. The observation cell comprises a transparent sleeve.

U.S. Patent Application #20020195471, published Dec. 26, 2002 by Nottingham, illustrates a plastic container and lid assembly for storing liquid coating materials including a container and a lid. The container has a body with a bottom wall, at least four sidewalls and a neck. The neck defines a wide mouth opening and including threads for receiving mating threads on the lid. The lid also has a plurality of lugs, preferably two lugs, extending radially from the lid and terminating at or before the lugs extend beyond the container sidewalls when the lid is in sealed engagement with the container. The body also has an integral handle for lifting the container and the container neck supports a bail-type handle also for lifting said container. The integral handle and bail-type handles do not extend beyond the container sidewall. The container and lid assembly having an effective packing footprint and an effective packing volume which substantially conforms to the effective packing footprint and the effective packing volume of a conventional metal paint can. The plastic container further includes a square sleeve fitting around said container to allow the container to be placed within a mechanical paint shaker apparatus.

What is needed is a rigid clear sleeve friction fit over a plastic paint bottle for shaking in a paint shaking machine to withstand the pressure of the paint mixing machine clamps and to enable a user to view when the paint is completely mixed.

### SUMMARY OF THE INVENTION

An object of the present invention is to provide a rigid clear transparent sleeve the same height as a plastic paint bottle friction fit over the plastic paint bottle for shaking it in a paint shaking machine to withstand the pressure of the paint mixing machine clamps and to enable a user to view when the paint is completely mixed.

Another object of the present invention is to provide a clear transparent sleeve in the form of a cylindrical clear acrylic rigid tube which can withstand the pressure of the paint mixing machine clamps and enable viewing of the paint being mixed as well as provide an exterior surface of the tube for imprinting with a logo and/or instructions.

In brief, a series of clear acrylic cylindrical tubes of different diameters and different lengths, each length corresponding to the height of a standard plastic paint bottle and each internal diameter corresponding to the external diameter of a standard plastic paint bottle, are provided to match the size of plastic paint bottle to be mixed in a standard paint mixing machine. The exterior of the tubes may be imprinted with the logo of the paint store, the tube supplier, the paint manufacturer or other logos and may include instructions for use.

An advantage of the present invention is that is enables shaking plastic paint bottles in standard paint mixing machines.

Another advantage of the present invention is that it enables viewing when the paint is fully mixed to stop the paint mixing machine.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a perspective view of the paint bottle sleeve of the present invention with a plastic paint bottle aligned for insertion in the sleeve;

FIG. 2 is a side elevational view of the paint bottle sleeve of the present invention held within the clamps of a paint mixing machine with a plastic paint bottle inside the tube.

### BEST MODE FOR CARRYING OUT THE INVENTION

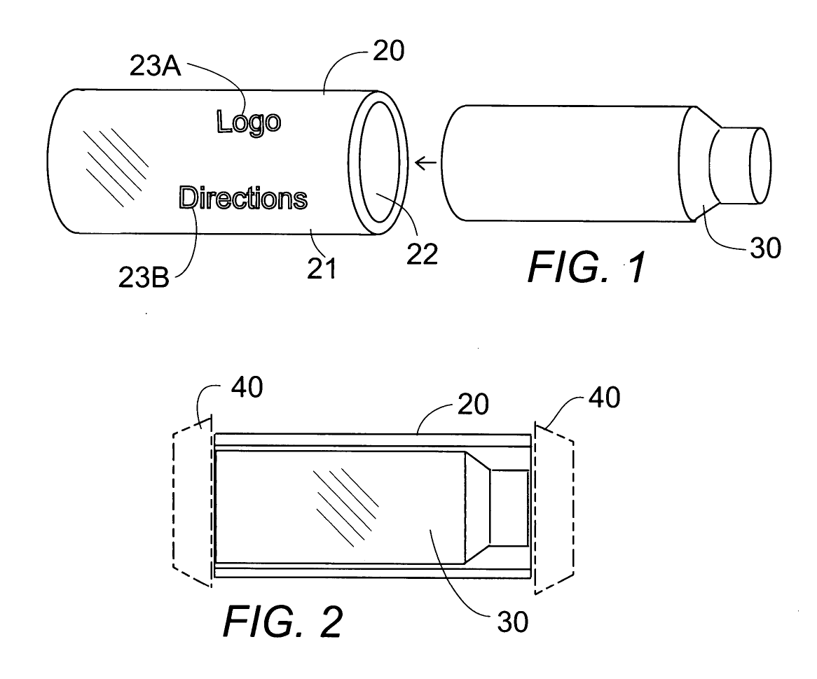

In FIGS. 1 and 2, a paint bottle retaining device comprises a paint bottle sleeve 20 for holding a bottle of paint 30 in the clamps 40 of a paint mixing machine.

The paint bottle sleeve 20 comprises a rigid hollow transparent cylinder equal in length to a height of a paint bottle 30. The paint bottle sleeve having an internal diameter 21 equal to an outer diameter of a paint bottle so that a paint bottle 30 fits within the paint bottle sleeve, as shown in FIG. 2, with the paint bottle sleeve 20 and paint bottle 30 contained therein both fit within the clamps 40 of a paint mixing machine.

The paint bottle sleeve 20 has a compression strength along a longitudinal axis sufficient to withstand the force of a paint mixing machine clamp 40 and a structural integrity to withstand a shaking motion of a paint mixing machine with a paint bottle contained within the paint bottle sleeve. The paint bottle sleeve 20 preferably fabricated of transparent acrylic plastic extruded into a hollow rigid cylinder so that the paint bottle 30 and paint contained within the paint bottle are visible through the paint bottle sleeve to visually determine when paint within the paint bottle is mixed to a desired extent.

The outer surface 22 of the paint bottle sleeve 20 may be imprinted with indicia, such as a logo 23A or directions 23B for use.

The paint bottle sleeves 20 are provided in different lengths and different internal diameters to match the variety of sizes of paint bottles.

In use, the paint bottle 30 is inserted within the paint bottle sleeve 20 and the combined bottle and sleeve held within a paint mixing machine clamp 40 which shakes the sleeve and paint bottle container until the paint is fully mixed as determined by visual inspection through the transparent sleeve.

It is understood that the preceding description is given merely by way of illustration and not in limitation of the invention and that various modifications may be made thereto without departing from the spirit of the invention as claimed.

What is claimed is:

1. A paint bottle retaining device for holding a bottle of paint in a paint mixing machine, the device comprising:
a paint bottle sleeve comprising a rigid hollow transparent cylinder equal in length to a height of a paint bottle, the paint bottle sleeve having an internal diameter equal to an outer diameter of a paint bottle so that a paint bottle fits within the paint bottle sleeve, the paint bottle sleeve having a compression strength along a longitudinal axis sufficient to withstand a force of a paint mixing machine clamp and a structural integrity to withstand a shaking motion of a paint mixing machine with a paint bottle contained within the paint bottle sleeve, the paint bottle sleeve having at least one transparent portion so that the paint bottle and paint contained within the paint bottle are visible through the paint bottle sleeve to visually determine when paint within the paint bottle is mixed to a desired extent.

2. The device of claim 1 wherein an outer surface of the paint bottle sleeve is imprinted with indicia.

3. The device of claim 1 wherein the paint bottle sleeve is fabricated of extruded transparent acrylic plastic.
